(19) United States
(12) Patent Application Publication
(10) Pub. No.: US 2017/0021864 A1
(43) Pub. Date: Jan. 26, 2017

(54) DEVICE AND METHOD FOR OPERATING A VEHICLE

(71) Applicant: Robert Bosch GmbH, Stuttgart (DE)

(72) Inventors: Erich Sonntag, Marbach Am Neckar (DE); Marc Arnon, Benningen Am Neckar (DE)

(21) Appl. No.: 15/124,279

(22) PCT Filed: Jan. 29, 2015
(86) PCT No.: PCT/EP2015/051845

§ 371 Date: Sep. 7, 2016

(30) Foreign Application Priority Data
Mar. 10, 2014 (DE) 10 2014 204 309.3

(51) Int. Cl. B62D 15/02; G05D 1/02

(52) U.S. Cl. CPC B62D 15/0255; G05D 1/021; G05D 1/0257; G05D 1/0255; G05D 1/0246; G05D 1/024

(57) ABSTRACT

A method for operating a vehicle, including detecting a surroundings of the vehicle; subdividing the detected surroundings into cells of an occupancy grid, the cells respectively having opposite lateral boundaries relative to a longitudinal axis of the vehicle, the lateral boundaries being formed by lane markings; ascertaining, based on the detected surroundings, an occupancy value of the specific cell into which the vehicle intends to change by a lane change; performing the lane change as a function of the ascertained occupancy value. A corresponding device as well as a corresponding computer program are also described.

### FIELD

The present invention relates to a method and a device for operating a vehicle. The present invention further relates to a computer program.

### BACKGROUND INFORMATION

German Patent Application No. DE 100 12 737 A1 shows a device for the performance of a lane change by a motor vehicle.

German Patent Application No. DE 10 2006 043 149 A1 shows an integrated lateral guidance and longitudinal guidance assistant for supporting the driver in a lane change.

European Patent No. EP 1 777 143 A1 shows a freeway assistant for semi-autonomous driving for a motor vehicle having a lane change assistant.

### SUMMARY

An object of the present invention is to provide a method for operating a vehicle.

An object of the present invention is to provide a method for operating a vehicle.

An objective of the present invention is to provide a computer program.

According to one aspect, a method for operating a vehicle is provided, including the following steps:
detecting a surroundings of the vehicle,
subdividing the detected surroundings into cells of an occupancy grid,
the cells respectively having two opposite lateral boundaries relative to a longitudinal axis of the vehicle,
the lateral boundaries being formed by lane markings,
ascertaining, based on the detected surroundings, an occupancy value of the specific cell into which the vehicle intends to change by a lane change,
performing the lane change as a function of the ascertained occupancy value.

According to another aspect, a device for operating a vehicle is provided, which includes:
a detection device for detecting a surroundings of the vehicle,
a processing device for subdividing the detected surroundings into cells of an occupancy grid,
the cells respectively having two opposite lateral boundaries relative to a longitudinal axis of the vehicle,
the lateral boundaries being formed by lane markings,
the processing device being designed to ascertain, based on the detected surroundings, an occupancy value of the specific cell into which the vehicle intends to change by a lane change, and
a guidance device for guiding the vehicle, which is designed to perform the lane change as a function of the ascertained occupancy value.

According to yet another aspect, a computer program is provided, which includes program code for implementing the method for operating a vehicle when the computer program is executed on a computer, in particular on a processing device.

The present invention thus comprises in particular the idea of forming the lateral boundaries of the cells of the occupancy grid by the lane markings. This means in particular that a distance between the two lateral boundaries of the cell corresponds to a width of the lane. Advantageously, the entire width of the lane is thereby taken into account in the decision of whether or not a lane change is to be performed. The width of the lane is a useful variable with respect to the decision as to whether or not the lane change is to be performed. A smaller cell width is not necessary. This makes it possible for example to reduce a computing time and a memory requirement in comparison to smaller cell widths.

The fact that the lane change is performed as a function of the ascertained occupancy value means in particular that lane change is performed or is not preformed depending on the ascertained occupancy value. In particular, one specific embodiment may provide for the ascertained occupancy value to be compared to an occupancy threshold value. Depending on the comparison, the lane change is performed or not performed. Particularly if the ascertained occupancy value is smaller than the predetermined occupancy threshold value, the lane change is performed. Particularly if the ascertained occupancy value is greater than the predetermined occupancy threshold value, no lane change is performed. For example, if the ascertained occupancy value is equal to the occupancy threshold value, then there may be a provision either to perform a lane change or not.

An occupancy grid in the sense of the present invention includes multiple cells. In particular, one occupancy value, which may in particular be called occupancy, is assigned to each cell. An occupancy value may include for example a probability value or may be such a probability value. Such a probability value is a measure for the probability that this cell is occupied by an object, for example another vehicle. This means in particular that at the position in the surroundings of the vehicle corresponding to this cell the object is located in accordance with the probability. The occupancy value may in particular also be called an occupancy probability.

A cell having a probability value that is greater than a predetermined probability value, for example 1%, preferably 5%, in particular 10%, may be designated as an occupied cell. A cell having a probability value smaller than the predetermined probability threshold value may be designated as a non-occupied or unoccupied cell.

According to one specific embodiment, it is also possible to ascertain occupancy values for at least some additional cells of the occupancy grid, preferably for all cells of the occupancy grid, and to do so in particular as a function of the detected surroundings. This may be done in particular analogously to the ascertainment of the occupancy value of the specific cell into which the vehicle intends to change by a lane change.

According to one specific embodiment, it may be provided that the detection device includes one or more surround sensors. The plurality of surround sensors may, in particular, be developed to be identical or preferably different. Such surround sensors may be for example an ultrasonic sensor, a radar sensor, a video sensor, laser sensor or a lidar sensor or a sensor based on Car2X technology. The detection device may include in particular a stereo video camera including one or multiple video sensors.

This thus means in particular that the aforementioned surround sensors are able to detect the surroundings of the vehicle in sensory fashion.

According to one specific embodiment, it may be provided that the cells respectively have two opposite longitudinal boundaries relative to the longitudinal axis of the vehicle, a distance between the two longitudinal boundaries of a cell being formed as a function of a behavior parameter that characterizes a driving behavior of the driver.

This advantageously makes it possible to take into account different driving behaviors. A cell area thus increases or decreases in size depending on the behavioral parameter. In case of a conservative driving behavior, a distance is greater than a length of a vehicle. In case of an aggressive driving behavior, the distance equals the length of the vehicle.

A conservative driving behavior differs from an aggressive driving behavior primarily in that an aggressively driving driver would still change into spaces in the adjacent lane into which a conservatively driving driver no longer changes. A further background consideration in this regard is also to what extent the driver accepts the fact that as a result of the lane change the following traffic in the target lane is impacted negatively (that is to say, for example, that it is forced to brake). The larger the cell (that is, in particular, the larger the distance between the two longitudinal boundaries of a cell), the more space is accorded to the following traffic for reacting to the lane change. The same applies for the additional consideration of the relative speed in the preceding and following neighboring cells.

Another specific embodiment may provide for a lane change probability to be ascertained for the specific cell into which the vehicle intends to change by way of a lane change, the lane change probability corresponding to a probability for a lane change of another vehicle into the cell, the implementation of the lane change being carried out as a function of the lane change probability.

A cell may be designated as free or indicated as unoccupied. Nevertheless, a lane change into this cell may not be expedient if, for example, another vehicle also intends to change into this cell. This may result in particular in a dangerous situation. In such a situation, the risk of an accident is increased in particular.

By ascertaining the lane change probability and the correspondingly depending performance of the lane change, it is advantageously possible to avoid such critical situations. For here the probability is advantageously taken into account that another vehicle likewise intends to change into precisely this cell into which the host vehicle intends to change.

Another specific embodiment may provide for the occupancy value to be ascertained as a function of an existence probability of a detected object in the cell.

Generally, an object in the sense of the present invention may be another vehicle. A relative speed generally designates in particular a relative speed between the object and the vehicle. An object position designates in particular a position of the object within the cell, that is, in particular relative to the lateral and/or longitudinal boundaries of the cell.

The existence probability indicates in particular the probability that the object exists in the cell. For it is possible that an object was detected in the cell. Yet it may be the case that this is not a real object. The cause of this may be measuring errors or noise. Particularly if the object was detected by a surround sensor, such a detection is normally encumbered with an uncertainty. This is thus advantageously taken into account via the existence probability.

Another specific embodiment may provide for the occupancy value to be ascertained as a function of an object position of an object in the cell relative to the boundaries of the cell. Variance distributions are generated around the object position, which result from the measuring and tracking process. These variances correspond to a probability density function. By integration of this probability density function within the boundaries of the cells—in combination with additional values such as, for example, the existence probability—one obtains the probability that an object is actually located within the respective cell. By this procedure, the uncertainties from the measuring process are propagated all the way to the function and are included in the decision about a lane change.

The boundaries may be in particular the longitudinal and/or the lateral boundaries.

Another specific embodiment may provide for the occupancy value to be ascertained as a function of a relative speed of an object in the cell relative to the boundaries of the cell.

That is to say, in particular, that the higher the relative speed, the more relevant it is for ascertaining the occupancy value. In this respect, the occupancy value will turn out to be accordingly higher. Conversely, the lower the relative speed, the less relevant it is for the ascertainment and the lower will be accordingly the occupancy value.

Yet another specific embodiment may provide for the relative speed to be weighted as a function of a distance of the object from the vehicle. The relative speed is in particular weighted higher, the closer the object (longitudinal) is to the host vehicle.

Still another specific embodiment may provide for the detection of the surroundings to include a detection of the surroundings using a surround sensor, the occupancy value being ascertained as a function of a variance of measuring values of the surround sensor corresponding to the detected surroundings. This is in particular a variance in the stochastic sense.

One specific embodiment may provide for the guiding device to be developed for guiding the vehicle in an at least partially automated, preferably fully automated manner, and to do so in particular as a function of the ascertained occupancy value, in particular of the ascertained occupancy values of the individual cells of the occupancy grid. That is to say, in particular, that the guiding device guides the vehicle at least in a partially automated, preferably fully automated manner. In a partially automated guidance, a driver of the vehicle must still personally intervene in the guidance of the vehicle in addition to the guidance by way of the guiding device. In a fully automated guidance, the guiding device guides the vehicle entirely. Here, it is no longer necessary for the driver to intervene in the guidance of the vehicle.

The present invention is explained in greater detail below with reference to preferred exemplary embodiments.

### BRIEF DESCRIPTION OF THE DRAWINGS

FIG. 1 shows a flow chart of a method for operating a vehicle.

FIG. 2 shows a device for operating a vehicle.

FIG. 3 shows an occupancy grid.

### DETAILED DESCRIPTION OF EXAMPLE EMBODIMENTS

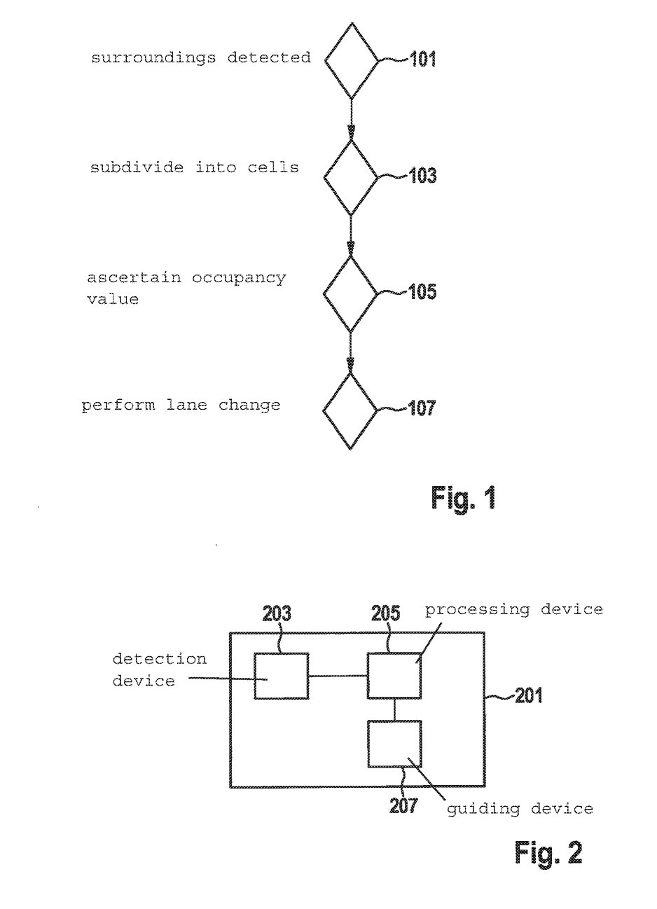

FIG. 1 shows a flow chart of a method for operating a vehicle. According to a step 101, a surroundings of the vehicle is detected. This occurs in particular by way of a detection device, which may include for example one or more surround sensors. According to a step 103, the detected surroundings are subdivided into cells of an occupancy grid, the cells each having two opposite lateral boundaries relative to a longitudinal axis of the vehicle, the lateral boundaries being formed by lane markings. The subdivision may be performed for example by a processing device, for example by a computer.

In a step 105, an occupancy value of the specific cell is ascertained into which the vehicle intends to change by a lane change. The ascertainment of the occupancy value is performed for example by a processing device, in particular by a computer. In a step 107, the lane change is performed as a function of the ascertained occupancy value. This occurs in particular by way of a guiding device.

FIG. 2 shows a device 201 for operating a vehicle (not shown).

Device 201 includes a detection device 203 for detecting a surroundings of the vehicle. Detection device 203 may include for example one or more surround sensors.

Device 201 further includes a processing device 205 for subdividing the detected surroundings into cells of an occupancy grid, the cells each having two opposite lateral boundaries relative to a longitudinal axis of the vehicle, the lateral boundaries being formed by lane markings.

Processing device 205 is designed to ascertain an occupancy value of the specific cell into which the vehicle intends to change by a lane change. Processing device 205 is designed in particular to ascertain respective occupancy values for additional cells of the occupancy grid.

Device 201 further includes a guiding device 207 for guiding the vehicle, guiding device 207 being designed to carry out the lane change as a function of the ascertained occupancy value or the ascertained occupancy values. For guiding the vehicle, the guiding device is preferably in operative connection with one or multiple actuators or setters of the vehicle.

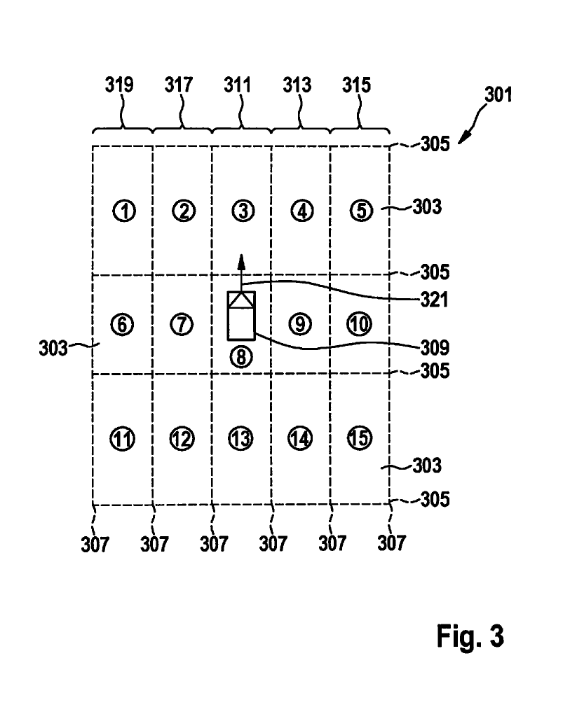

FIG. 3 shows an occupancy grid 301.

Occupancy grid 301 includes multiple cells 303, which are numbered consecutively from 1 through 15. It should be noted that the concrete number of cells as shown in FIG. 3 is not restrictive, but merely exemplary. In further exemplary embodiments that are not shown, more or fewer than 15 cells may be provided for an occupancy grid.

Vehicle 309, which has detected its surroundings, is provided in cell “8” Vehicle 309 includes for this purpose a device of the present invention, which is not shown explicitly shown for reasons of clarity. Vehicle 309 may include for example the device 201 as shown in FIG. 2. Occupancy grid 301 is formed on the basis of the detected surroundings. A longitudinal axis of vehicle 309 is indicated by an arrow with reference numeral 321, the direction of travel of vehicle 309 here coinciding with longitudinal axis 321.

Reference numeral 305 indicates longitudinal boundaries of cells 303 with respect to longitudinal axis 321 of vehicle 309. Reference numeral 307 indicates lateral boundaries of the individual cells 303 relative to the longitudinal axis 321 of vehicle 309.

Lateral boundaries 307 of cells 303 correspond to lane markings or line markings and thus advantageously define the individual lane widths. This information may be gathered from a digital map for example. The lane markings may be detected in particular by the detection device, in particular by a video sensor.

Reference numeral 311 indicates the lane in which vehicle 309 is currently traveling. Reference numeral 317 indicates the directly adjacent left lane relative to lane 311. Reference numeral 319 indicates the directly adjacent left lane relative to lane 317. Reference numeral 313 indicates the directly adjacent right lane relative to lane 311. Reference numeral 315 indicates the directly adjacent right lane relative to lane 313.

For the individual cells 303, occupancy probabilities or occupancy values are initially calculated or ascertained, which a lane change function, for example the guiding device, is able to query in order to check whether a lane change is possible without risk.

The lateral boundaries 307 of the cells are oriented along the lane markings and determine the individual lane widths (this information may be gathered preferably from a digital map).

The longitudinal boundaries 305 of the cells divide the respective lanes into cells in front of (areas or cells 1-5), adjacent to (areas or cells 6-10) and behind (areas or cells 11-15) the host vehicle 309 and orient themselves:

on the one hand, according to how conservatively or aggressively the lane change is to be performed (conservatively: areas 6-10 are as large as possible, aggressively: areas 6-10 correspond to the length of the host vehicle 309);

on the other hand, according to the clearance requirements of the transverse trajectory for the lane change.

The occupancy probabilities for the individual cells are calculated by suitable mathematical methods at least from the following items of information:

for cells 1-5 and 11-15, from the probability of the existence and the object position of a detected object (for example another vehicle) in these cells relative to the lateral and longitudinal cell boundaries as well as from the longitudinal relative speeds with respect to an object speed and a vehicle speed of vehicle 309 as well as from the corresponding variances of the measured values from the surround sensors. In these cells 1-5 and 11-15, the relative speed enters the calculation of the occupancy probability in a manner weighted via a characteristic curve, that is, concretely: if another or further vehicle approaches host vehicle 309 longitudinally in an adjacent lane 313, 315, 317, 319, then it becomes more relevant (via the occupancy probability), the closer it approaches host vehicle 309.

For cells 6-10, the occupancy probabilities are calculated from the probability of the existence as well as the object position of a detected object (for example a further vehicle) relative to the lateral and longitudinal cell boundaries as well as from the corresponding variances of the measured values from the surround sensors. In these cells 6-10, the relative speed does not enter into the calculation of the occupancy probabilities since these cells are directly adjacent to host vehicle 309. Because these cells are directly adjacent to the host vehicle, the mere presence of another vehicle is reason enough not to perform a lateral movement of a lane change, regardless of how high is the relative speed of the vehicle.

Additionally, a lane change probability is calculated for the individual cells 303 from the lateral speeds and the corresponding variances. By taking the lane change probabilities within the lane change function into account, it is possible to avoid critical situations that arise when two vehicles intend to change into the same lane laterally from different directions.

1-10. (canceled)

11. A method for operating a vehicle, the method comprising:
detecting a surroundings of the vehicle;
subdividing the detected surroundings into cells of an occupancy grid, the cells relative to a longitudinal axis of the vehicle respectively having two opposite lateral boundaries, the lateral boundaries being formed by lane markings;
ascertaining, based on the detected surroundings, an occupancy value of the specific cell into which the vehicle intends to change by a lane change; and
performing the lane change as a function of the ascertained occupancy value.

12. The method as recited in claim 11, wherein
the cells relative to a longitudinal axis of the vehicle respectively having two opposite longitudinal boundaries, a distance between the two longitudinal boundaries of a cell being formed as a function of a behavioral parameter characterizing a driving behavior of the driver.

13. The method as recited in claim 11, wherein a lane change probability is ascertained for the specific cell into which the vehicle intends to change by the lane change, the lane change probability corresponding to a probability for a lane change of a further vehicle into the cell, the performance of the lane change being carried out as a function of the lane change probability.

14. The method as recited in claim 11, wherein the occupancy value is ascertained as a function of an existence probability of a detected object in the cell.

15. The method as recited in claim 11, wherein the occupancy value is ascertained as a function of an object position of an object in the cell relative to the boundaries of the cell.

16. The method as recited in claim 11, wherein the occupancy value is ascertained as a function of a relative speed of an object in the cell relative to the boundaries of the cell.

17. The method as recited in claim 16, wherein the relative speed is weighted as a function of a distance of the object from the vehicle.

18. The method as recited in claim 11, wherein the detection of the surroundings includes a detection of the surroundings by a surround sensor, the occupancy value being ascertained as a function of a variance from measured values of the surround sensor corresponding to the detected surroundings.

19. A device for operating a vehicle, comprising:
a detection device to detect a surroundings of the vehicle;
a processing device for subdividing the detected surroundings into cells of an occupancy grid, the cells relative to a longitudinal axis of the vehicle respectively having two opposite lateral boundaries, the lateral boundaries being formed by lane markings, the processing device being designed to ascertain, based on the detected surroundings, an occupancy value of the specific cell into which the vehicle intends to change by a lane change; and
a guidance device for guiding the vehicle, which is designed to perform the lane change as a function of the ascertained occupancy value.

20. A non-transitory computer-readable storage medium storing a computer program including program code for operating a vehicle, the program code, when executed by a computer, causing the computer to perform:
detecting a surroundings of the vehicle;
subdividing the detected surroundings into cells of an occupancy grid, the cells relative to a longitudinal axis of the vehicle respectively having two opposite lateral boundaries, the lateral boundaries being formed by lane markings;
ascertaining, based on the detected surroundings, an occupancy value of the specific cell into which the vehicle intends to change by a lane change; and
performing the lane change as a function of the ascertained occupancy value.
